(19) United States
(12) Patent Application Publication
(10) Pub. No.: US 2025/0223484 A1
(43) Pub. Date: Jul. 10, 2025

(54) PREPARATION OF METAL OXIDE NANOPARTICLES FROM CATHODES OF LITHIUM-ION BATTERIES

(71) Applicant: Saudi Arabian Oil Company, Dhahran (SA)

(72) Inventors: Madina Baltaeva, Moscow (RU); Anton Manakhov, Ivanovo (RU); Nikita Akhmetov, Novosibirsk (RU); Andrey Lunchev, Moscow (RU); Vikrant Wagle, Dhahran (SA)

(21) Appl. No.: 18/407,917

(22) Filed: Jan. 9, 2024

(51) Int. Cl. C09K 8/05; C01G 45/02; C01G 51/04; C01G 53/04; E21B 21/06

(52) U.S. Cl. CPC C09K 8/05; C01G 45/02; C01G 51/04; C01G 53/04; E21B 21/065; C01P 2004/61; C01P 2004/62; C01P 2004/64

(57) ABSTRACT

The disclosure relates to methods to prepare metal oxide nanoparticles (MONs) from the cathodes of lithium-ion batteries (LIBs), and related compositions and systems. The MONs can be used to improve the properties of drilling fluids, such as those used in underground drilling methods to produce oil and/or natural gas.

### FIELD

The disclosure relates to methods to prepare metal oxide nanoparticles (MONs) from the cathodes of lithium-ion batteries (LIBs), and related compositions and systems. The MONs can be used to improve the properties of drilling fluids, such as those used in underground drilling methods to produce oil and/or natural gas.

### BACKGROUND

Drilling fluids are commonly used in underground drilling methods. Typically, in such methods, the drilling fluid is in direct contact with the wellbore. The drilling fluid should have appropriate rheological and thermophysical characteristics. Nanoparticles can be employed as additives in drilling fluids.

### SUMMARY

The disclosure relates to methods to prepare MONs from the cathodes of LIBs, and related compositions and systems. The MONs can be used to improve the properties of drilling fluids, such as those used in underground drilling methods to produce oil and/or natural gas.

The methods can allow for the use of spent cathodes of LIBs and can be relatively robust, inexpensive, and/or environmentally friendly relative to certain other methods for processing spent cathodes of LIBs. The methods can be more energy efficiency and/or use milder conditions, such as relatively low temperatures and non-toxic chemicals, to process the spent cathodes of LIBs, relative to certain other methods to process spent cathodes of LIBs. The methods can provide higher recovery of metals from spent cathodes of LIBs relative to certain other methods for processing spent cathodes of LIBs. Additionally, the MONs can be less expensive to prepare relative to certain other nanoparticles.

Inclusion of the MONs in the drilling fluid can improve the rheological properties of the drilling fluid, such as yield point, plastic viscosity, and/or gel strength. The drilling fluids can have reduced fluid losses, decreased differential pipe adhering, improved drilling mud stability under high pressure and temperature (HPHT) conditions, reduced coefficient of friction, and enhanced shale stability relative to certain other drilling fluids. Without wishing to be bound by theory, it is believed that the nanoparticles can penetrate into rock with relatively low permeability (e.g., the pore sizes do not exceed 0.1-1 μm) and clog them, thereby reducing filter loss. The nanoparticles can be used as a weighting material in the drilling fluid and can be less expensive than certain other weighting materials. The density of the drilling fluid can be increased by the addition of the MONs.

Due the electronic properties of certain MONs (e.g., cobalt oxide nanoparticles (Co₃O₄)), the nanoparticles can be relatively quickly and/or easily separated from fluids, for example, through the application of a magnetic field. Thus, the MONs can be recovered from drilling fluids and reused.

In a first aspect, the disclosure provides a method, including: dissolving a cathode material including a metal using a leaching solution including an acidic agent and a reducing agent to provide a first solution including ions of the metal; adding a second solution including oxalic acid and/or an oxalate salt to the first solution to precipitate a metal oxalate; and calcining the metal oxalate to form metal oxide nanoparticles.

In some embodiments, the leaching solution includes from 0.5 M to 2 M of the acidic agent and from 2 vol. % to 10 vol. % of the reducing agent.

In some embodiments, the acidic agent includes sulfuric acid, citric acid, tartaric acid, acetic acid, glycolic acid, maleic acid, succinic acid, acrylic acid, lactic acid, benzoic acid, and/or propionic acid. In some embodiments, the reducing agent includes hydrogen peroxide, sodium bisulfite, ascorbic acid, and/or citric acid. In some embodiments, the reducing agent is different from the acidic agent.

In some embodiments, dissolving the cathode material is performed at a temperature of from 60° C. to 80° C.

In some embodiments, the calcining is performed at a temperature of from 250° C. to 450° C.

In some embodiments, the calcining is performed for from 1 hour to 4 hours.

In some embodiments, the metal oxide nanoparticles include nickel oxide, manganese oxide and/or cobalt oxide.

In some embodiments, the metal oxide nanoparticles include from 0 to 99 wt. % nickel oxide, from 0 to 99 wt. % manganese oxide, and/or from 0 to 99 wt. % cobalt oxide.

In some embodiments, the metal oxide nanoparticles have a size of from 10 nm to 10000 nm.

In some embodiments, the method further includes, prior to adding the second solution, adjusting a pH of the first solution to 2 to 7.

In some embodiments, the method further includes, prior to dissolving the cathode material, isolating the cathode material from at least one other component of a lithium-ion battery, including contacting the cathode material with a solvent.

In some embodiments, contacting the cathode material with a solvent is performed at a temperature of from 65° C. to 90° C.

In some embodiments, the method further includes, prior to isolating the cathode material from at least one other component of a lithium-ion battery, dismantling a lithium-ion battery cell or bundle.

In some embodiments, the method further includes, prior to dismantling the lithium-ion battery cell or bundle, discharging the lithium-ion battery cell or bundle, including immersing the lithium-ion battery cell or bundle in an alkali solution.

In some embodiments, the alkali solution has a concentration of an alkali agent of from 5 wt. % to 15 wt. %.

In some embodiments, the method further includes forming a drilling fluid including the metal oxide nanoparticles.

In some embodiments, the drilling fluid is a water-based drilling fluid.

In some embodiments, the drilling fluid includes from 0.005 wt. % to 10 wt. % of the metal oxide nanoparticles.

In some embodiments, the method further includes using the drilling fluid in a drilling operation.

In some embodiments, the method further includes recovering at least a portion of the drilling fluid after the drilling operation, and recovering at least a portion of the metal oxide nanoparticles from the recovered drilling fluid.

### BRIEF DESCRIPTION OF THE FIGURES

FIG. 1 depicts a flowchart for a method.

FIG. 2 depicts a schematic of a system.

FIG. 3 depicts a schematic for a method.

### DETAILED DESCRIPTION

### Methods to Form Metal Oxide Nanoparticles

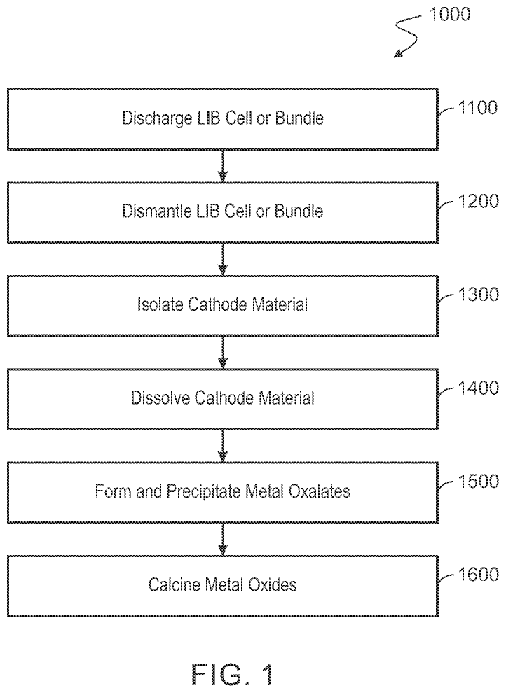

FIG. 1 depicts a flowchart for a method 1000 of forming MONs from the cathode of LIBs. In general, the cathodes can include LiNiO₂, LiMnO₂, LiCoO₂, and/or LiNiₓMn_{y}Co₂O₂.

In step 1100 a LIB cell or bundle is discharged. In general, the discharging can be performed by any appropriate method, such as immersion into an alkali solution. The alkali agent can include any appropriate alkali agent, such as, for example, K₂CO₃. Na₂CO₃, and/or NH₄HCO₃. In some embodiments, the alkali solution has a concentration of the alkali agent of at least 5 (e.g., at least 6, at least 7, at least 8, at least 9, at least 10, at least 11, at least 12, at least 13, at least 14) wt. % and/or at most 15 (e.g., at most 14, at most 13, at most 12, at most 11, at most 10, at most 9, at most 8, at most 7, at most 6) wt. %. In some embodiments, the alkali solution has a pH of at least 8 (e.g., at least 9, at least 10, at least 11, at least 12, at least 13) and/or at most 14 (e.g., at most 13, at most 12, at most 11, at most 10, at most 9). In some embodiments, the LIB cell or bundle is immersed in the alkali solution for at least 12 (e.g., at least 18, at least 24, at least 30, at least 36, at least 42) hours and/or at most 48 (e.g., at most 42, at most 36, at most 30, at most 24, at most 18) hours. Without wishing to be bound by theory, it is believed that in general the temperature does not significantly impact the discharging.

In general, the discharging is performed to suppress the voltage of the LIB cell or bundle to a voltage sufficiently low to allow for safe dismantling of the LIB cell or bundle. In some embodiments, the LIB cell's voltage is 3.5-4.0 V prior to the discharging and/or 1.0-2.0 V after the discharging.

In step 1200, the LIB cell or bundle is dismantled. The dismantling can include removing stainless-steel battery cases and unwinding the cathode from the rod which it is wound around. The dismantling can be performed immediately after removal from the alkali solution in the step 1100. Generally, the cathode (e.g., in the form of a tape) is washed with a solvent, such as a C₁₋₃ alcohol (e.g., ethanol, isopropanol), dried and cut into pieces. In certain embodiments, the drying is performed at a temperature of at least 65 (e.g., 70, at least 75, at least 80° C.) and/or at most 85 (e.g., at most 80, at most 75, at most 70° C.) In certain embodiments, the cathode (e.g., the cathode tape) is cut into pieces with a size of at least 1 (e.g., at least 2, at least 3, at least 4, at least 5, at least 6, at least 7, at least 8, at least 9) cm² and/or at most 10 (e.g., at most 9, at most 8, at most 7, at most 6, at most 5, at most 4, at most 3, at most 2) cm². In certain embodiments, the cathode (e.g., the cathode tape) is cut into 2 cm² pieces. Without wishing to be bound by theory, it is believed that cutting the cathode into pieces can make the method 1000 easier to perform.

Dismantling in step 1200 can also include addressing other components in the LIB cell or bundle. For example, step 1200 can include immersing an anode and/or separator into an alkali solution to neutralize fluorine-containing anions present in the liquid electrolyte of the dismantled battery cells.

In step 1300, the cathode separated in the step 1200 from other cell components is further processed to isolate the cathode active material from other components of the cathode, such as polymeric binder and conductive carbon additive. This can includes contacting the cut cathode with a solvent, such as DMF, DMSO, or NMP, to remove the polymeric binder and to simultaneously detach the cathode active material from the aluminum substrate. The cut cathode and solvent are mixed under relatively mild conditions and the obtained product is filtered, washed, and dried (e.g., using a vacuum oven). In some embodiments, the battery cell includes at least 20 (e.g., at least 25, at least 30, at least 35) wt. % and/or at most 40 (e.g., at most 35, at most 30, at most 25) wt. % cathode material. Without wishing to be bound by theory, it is believed that from one LIB cell, it is possible to obtain 5 to 20 g of cathode material.

In certain embodiments the amount of solvent relative to the amount of cathode material in the step 1300 is at least 3 (e.g., at most 4, at most 5, at most 6, at most 7, at most 8, at most 9) mL/g and/or at most 10 (e.g., at most 9, at most 8, at most 7, at most 6, at most 5, at most 4) ml/g.

In some embodiments, the mixing is performed at a temperature of at least 65 (e.g., at least 70, at least 75, at least 80, at least 85° C.) and/or at most 90 (e.g., at most 85, at most 80, at most 75, at most 70° C.) In some embodiments, the mixing is performed for at least 2 (e.g., at least 3, at least 4, at least 5, at least 6, at least 7) hours and/or at most 8 (e.g., at most 7, at most 6, at most 5, at most 4, at most 3) hours.

In certain embodiments, the washing is performed with a C₁₋₃ solvent, such as ethanol or isopropanol. In certain embodiments, the drying is performed for at least 1 (e.g., at least 2, at least 4, at least 6, at least 8, at least 10, at least 12, at least 14, at least 16, at least 18, at least 20, at least 22, at least 24, at least 26, at least 28, at least 30, at least 32, at least 34) hours and/or at most 36 (e.g., at most 34, at most 32, at most 30, at most 24, at most 18, at most 16, at most 14, at most 12, at most 10, at most 8, at most 6, at most 4, at most 2) hours. In some embodiments, the drying is performed at a temperature of at least 25 (e.g., at least 30, at least 35, at least 40, at least 45, at least 50, at least 55, at least 60, at least 65, at least 70, at least 75, at least 80, at least 85° C.) and/or at most 90 (e.g., at most 85, at most 80, at most 75, at most 70, at most 65, at most 60, at most 55, at most 50, at most 45, at most 40, at most 35, at most 30° C.) In some embodiments, the drying is performed at a pressure of at least 1 (e.g., at least 2, at least 5, at least 10, at least 15, at least 20, at least 25, at least 30, at least 35, at least 40, at least 45, at least 50, at least 55, at least 60, at least 65, at least 70, at least 75, at least 80, at least 85, at least 90, at least 95) mBar and/or at most 100 (e.g., at most 95, at most 90, at most 85, at most 80, at most 75, at most 70, at most 65, at most 60, at most 55, at most 50, at most 45, at most 40, at most 35, at most 30, at most 25, at most 20, at most 15, at most 10, at most 5, at most 2) mBar. In some embodiments, the drying is performed under vacuum.

In step 1400, the cathode material is dissolved using a leaching solution including an acidic agent and a reducing agent to dissolve the cathode material and convert metals present in the cathode materials into ionic form in solution. The metals present in the cathode material can include lithium, nickel, manganese, and/or cobalt. The dissolution is carried out under intensive stirring. After the dissolution the carbon residue (typically 1-10 wt. %) is filtered out.

In some embodiments, the leaching solution includes at least 0.5 (e.g., at least 0.6, at least 0.7, at least 0.8, at least 0.9, at least 1.0, at least 1.1, at least 1.2, at least 1.3, at least 1.4, at least 1.5, at least 1.6, at least 1.7, at least 1.8, at least 1.9) M and/or at most 2.0 (e.g., at most 1.9, at most 1.8, at most 1.7, at most 1.6, at most 1.5, at most 1.4, at most 1.3, at most 1.2, at most 1.1, at most 1.0, at most 0.9, at most 0.8, at most 0.7, at most 0.6) M of the acidic agent. In some embodiments, the leaching solution includes at least 2 (e.g., at least 3, at least 4, at least 5, at least 6, at least 7, at least 8, at least 9) vol. % and/or at most 10 (e.g., at most 9, at most 8, at most 7, at most 6, at most 5, at most 4, at most 3) vol. % of the reducing agent.

The acidic agent can include a mineral acid and/or an organic acid. Examples of mineral acids include sulfuric acid (H₂SO₄), hydrochloric acid (HCl), and phosphoric acid (H₃PO₄). Examples of organic acids include citric acid, tartaric acid, acetic acid, glycolic acid, maleic acid, succinic acid, acrylic acid, lactic acid, benzoic acid, and propionic acid. Examples of the reducing agent include hydrogen peroxide (H₂O₂), sodium bisulfite (NaHSO₃), ascorbic acid, and citric acid.

In certain embodiments, the leaching is performed at a pH of at least 0 (e.g., at least 0.5, at least 1, at least 1.5) and/or at most 2 (e.g., at most 1.5, at most 1, at most 0.5).

In certain embodiments, the dissolution is performed at a temperature of at least 60 (e.g., at least 61, at least 62, at least 63, at least 64, at least 65, at least 66, at least 67, at least 68, at least 69, at least 70, at least 71, at least 72, at least 73, at least 74, at least 75, at least 76, at least 77, at least 78, at least 79° C.) and/or at most 80 (e.g., at most 79, at most 78, at most 77, at most 76, at most 75, at most 74, at most 73, at most 72, at most 71, at most 70, at most 69, at most 68, at most 67, at most 66, at most 65, at most 64, at most 63, at most 62, at most 61° C.) In certain embodiments, the dissolution is performed for at least 1 (e.g., at least 2, at least 3, at least 4, at least 5) hour(s) and/or at most 6 (e.g., at most 5, at most 4, at most 3, at most 2) hours.

In some embodiments, the leaching efficiency of an element (Eᵢ) is calculated using the equation:

$${E}_{i} ( \% ) = \frac{{n}_{i} {M}_{cat}}{{m}_{cat} {χ}_{i}} \cdot 100 \%$$

where nᵢ is quantity (mol) of i element, M_{cat} is molar weight of the cathode (g/mol), m_{cat} is weight of the dissolved cathode powder (g), Xᵢ is molar fraction of the i element (from 0 to 1) obtained from the EDX analysis of the separated cathode active material powder.

In some embodiments, the leaching efficiency is at least 80 (e.g., at least 81, at least 82, at least 83, at least 84, at least 85, at least 86, at least 87, at least 88, at least 89, at least 90, at least 91, at least 92, at least 93, at least 94, at least 95, at least 96, at least 97) % and/or at most 98 (e.g., at most 97, at most 96, at most 95, at most 94, at most 93, at most 92, at most 91, at most 90, at most 89, at most 88, most 87, at most 86, at most 85, at most 84, at most 83, at most 82, at most 81) %. Without wishing to be bound by theory, it is believed that the leaching efficiency depends on the element (e.g., Ni, Co, Mn), the composition of the leaching solution, and the leaching conditions (e.g., temperature, time, pH). Without wishing to be bound by theory, it is believed that the leaching conditions can affect the leaching efficiency of an element significantly and often synergetically, which can make it non-trivial to distinguish their impacts without experimentation. Without wishing to be bound by theory, it is believed that increasing the temperature and/or the contact time can improve the leaching efficiency but can increase costs of the process in some cases. Without wishing to be bound by theory, it is believed that, in some embodiments, after a certain point the leaching efficiency cannot be enhanced further.

In step 1500, metal oxalates (having the empirical formula MC₂O₄, where M is a metal, such as, for example, nickel, manganese, and/or cobalt) are formed and precipitated. Without wishing to be bound by theory, it is believed that the metal oxalates precipitate upon formation. An aqueous solution of oxalic acid is reacted with the solution of dissolved cathode material obtained in step 1400. The reacting can be performed under gentle mixing and heating. The precipitated metal oxalates may then be centrifuged, washed, and dried. The metal oxalates correspond to the metals of the dissolved cathode material. For example, if the dissolved cathode material includes nickel, manganese, and/or cobalt, then the metal oxalates include nickel, manganese, and/or cobalt. In addition to or in alternative to oxalic acid, an oxalate salt (e.g., sodium oxalate, potassium oxalate, ammonium oxalate) can be used.

In certain embodiments, prior to the step 1500, the pH of the solution containing the dissolved cathode material is adjusted (e.g., increased) to a pH of at least 2 (e.g., at least 2.5, at least 3, at least 3.5, at least 4, at least 4.5, at least 5, at least 5.5, at least 6, at least 6.5) and/or at most 7 (e.g., at most 6.5, at most 6, at most 5.5, at most 5, at most 4.5, at most 4, at most 3.5, at least 3, at least 2.5). Without wishing to be bound by theory, it is believed that such a pH can increase (e.g., maximize) the efficiency (yield) of metal oxalate precipitation. In general, the pH can be adjusted (e.g., increased) using an alkaline solution, such as a solution of NaOH.

In some embodiments, the concentration of oxalic acid or oxalate salt (e.g., sodium oxalate, potassium oxalate, ammonium oxalate) in the aqueous solution is at least 0.5 (e.g., at least 0.6, at least 0.7, at least 0.8, at least 0.9, at least 1.0, at least 1.1, at least 1.2, at least 1.3, at least 1.4, at least 1.5, at least 1.6, at least 1.7, at least 1.8, at least 1.9) M and/or at most 2 (e.g., at most 1.9, at most 1.8, at most 1.7, at most 1.6, at most 1.5, at most 1.4, at most 1.3, at most 1.2, at most 1.1, at most 1.0, at most 0.9, at most 0.8, at most 0.7, at most 0.6) M. In some embodiments, the oxalic acid is reacted with the dissolved cathode metals at a pH of at least 2 (e.g., at least 3, at least 4, at least 5) and/or at most 6 (e.g., at most 5, at most 4, at most 3).

In certain embodiments, the mixing and heating is performed at a temperature of at least 40 (e.g., at least 45, at least 50, at least 55) and/or at most 60 (e.g., at most 55, at most 50, at most 45° C.) In certain embodiments, the mixing and heating is performed for a duration of at least 0.1 (e.g., at least 0.2, at least 0.3, at least 0.4, at least 0.5, at least 0.6, at least 0.7, at least 0.8, at least 0.9) hours and/or at most 1 (e.g., at most 0.9, at most 0.8, at most 0.7, at most 0.6, at most 0.5, at most 0.4, at most 0.3, at most 0.2) hours.

In some embodiments, the metal oxalates can be obtained with a yield of at least 80 (e.g., at least 81, at least 82, at least 83, at least 84, at least 85, at least 86, at least 87, at least 88, at least 89, at least 90, at least 91, at least 92, at least 93, at least 94, at least 95, at least 96, at least 97, at least 98) % and/or at most 99 (e.g., at most 98, at most 97, at most 96, at most 95, at most 94, at most 93, at most 92, at most 91, at most 90, at most 89, at most 88, at most 87, at most 86, at most 85, at most 84, at most 83, at most 82, at most 81) %.

In step 1600, the metal oxalates formed in step 1500 are calcined to MONs. In certain embodiments, the calcination is performed at a temperature of at least 250 (e.g., at least 300, at least 350, at least 400° C.) and/or at most 450 (e.g., at most 400, at most 350, at most 300° C.) In certain embodiments, the calcination is performed for at least 1 (e.g., at least 2, at least 3) hour(s) and/or at most 4 (e.g., at most 3, at most 2) hours. In general, the calcination should be performed in an oxidative atmosphere. In certain embodiments, the calcination is performed in air. Without wishing to be bound by theory, it is believed that the metal oxalates undergo thermal decomposition to provide the MONs. In certain embodiments, no solvents (e.g., water) and/or additives are present during the calcination.

Without wishing to be bound by theory, it is believed that a specific temperature regime and timing during calcination can lead to desirable MONs. Without wishing to be bound by theory, it is believed that the size of the MONs is controllable. For example, it is believed that, in some embodiments, the size of the MONs can be varied by adjusting the metal oxalate precursor and/or the calcination conditions, including calcination temperature, calcination time, heating ramp rate and atmosphere. Adjusting the metal oxalate precursor can include varying the precipitating agent (the oxalate-anion source: oxalic acid, potassium oxalate, sodium oxalate, ammonium oxalate). Without wishing to be bound by theory, it is believed that the heating temperature affects the agglomeration of the nanoparticles and increasing the temperature, the heating ramp rate, and/or the heating time increases the size of the nanoparticles.

In some embodiments, the MONs have a size of at least 10 (e.g., at least 20, at least 30, at least 40, at least 50, at least 60, at least 70, at least 80, at least 90, at least 100, at least 200, at least 300, at least 400, at least 500, at least 600, at least 700, at least 800, at least 900, at least 1000, at least 2000, at least 3000, at least 4000, at least 5000, at least 6000, at least 7000, at least 8000, at least 9000) nm and/or at most 10000 (e.g., at most 9000, at most 8000, at most 7000, at most 6000, at most 5000, at most 4000, at most 3000, at most 2000, at most 1000, at most 900, at most 800, at most 700, at most 600, at most 500, at most 400, at most 300, at most 200, at most 100, at most 90, at most 80, at most 70, at most 60, at most 50, at most 40, at most 30, at most 20) nm.

In certain embodiments, the calcination temperature is at least 200 (e.g., at least 250, at least 300, at least 350, at least 400, at least 450° C.) and/or at most 500 (e.g., at most 450, at most 400, at most 350, at most 300, at most 250° C.) In certain embodiments, the calcination time is at least 0.5 (e.g., at least 1, at least 1.5, at least 2, at least 2.5, at least 3, at least 3.5, at least 4, at least 4.5, at least 5, at least 5.5) hours and/or at most 6 (e.g., at most 5.5, at most 5, at most 4.5, at most 4, at most 3.5, at most 3, at most 2.5, at most 2, at most 1.5, at most 1) hours. In certain embodiments, the heating ramp rate during the calcination is at least 1 (e.g., at least 2, at least 3, at least 4, at least 5, at least 6, at least 7, at least 8, at least 9° C.)/min and/or at most 10 (e.g., at most 9, at most 8, at most 7, at most 6, at most 5, at most 4, at most 3, at most 2° C.)/min.

Generally, the composition of the metal(s) present in the MONs is determined by the metal(s) present in the cathode material in the LIBs. For example, MONs can include cobalt oxide, manganese oxide and/or nickel oxide provided that the cathode material includes cobalt, manganese and/or nickel. Alternatively or additionally, the cathode material can include aluminum, lithium, iron, and/or copper and the resulting MONs can include oxides of that metal.

In some embodiments, the MONs include at least 0 (e.g., at least 0.1, at least 0.2, at least 0.3, at least 0.4, at least 0.5, at least 0.6, at least 0.7, at least 0.8, at least 0.9, at least 1, at least 2, at least 3, at least 4, at least 5, at least 6, at least 7, at least 8, at least 9, at least 10, at least 15, at least 20, at least 25, at least 30, at least 35, at least 40, at least 45, at least 50, at least 55, at least 60, at least 65, at least 70, at least 75, at least 80, at least 85, at least 90, at least 95) wt. % and/or at most 99 (e.g., at most 95, at most 90, at most 85, at most 80, at most 75, at most 70, at most 65, at most 60, at most 55, at most 50, at most 45, at most 40, at most 35, at most 30, at most 25, at most 20, at most 15, at most 10, at most 9, at most 8, at most 7, at most 6, at most 5 at most 4, at most 3, at most 2, at most 1, at most 0.9, at most 0.8, at most 0.7, at most 0.6, at most 0.5, at most 0.4, at most 0.3, at most 0.2, at most 0.1) wt. % of cobalt oxide. In some embodiments, the MONs include at least 0 (e.g., at least 0.1, at least 0.2, at least 0.3, at least 0.4, at least 0.5, at least 0.6, at least 0.7, at least 0.8, at least 0.9, at least 1, at least 2, at least 3, at least 4, at least 5, at least 6, at least 7, at least 8, at least 9, at least 10, at least 15, at least 20, at least 25, at least 30, at least 35, at least 40, at least 45, at least 50, at least 55, at least 60, at least 65, at least 70, at least 75, at least 80, at least 85, at least 90, at least 95) wt. % and/or at most 99 (e.g., at most 95, at most 90, at most 85, at most 80, at most 75, at most 70, at most 65, at most 60, at most 55, at most 50, at most 45, at most 40, at most 35, at most 30, at most 25, at most 20, at most 15, at most 10, at most 9, at most 8, at most 7, at most 6, at most 5 at most 4, at most 3, at most 2, at most 1, at most 0.9, at most 0.8, at most 0.7, at most 0.6, at most 0.5, at most 0.4, at most 0.3, at most 0.2, at most 0.1) wt. % of nickel oxide. In some embodiments, the MONs include at least 0 (e.g., at least 0.1, at least 0.2, at least 0.3, at least 0.4, at least 0.5, at least 0.6, at least 0.7, at least 0.8, at least 0.9, at least 1, at least 2, at least 3, at least 4, at least 5, at least 6, at least 7, at least 8, at least 9, at least 10, at least 15, at least 20, at least 25, at least 30, at least 35, at least 40, at least 45, at least 50, at least 55, at least 60, at least 65, at least 70, at least 75, at least 80, at least 85, at least 90, at least 95) wt. % and/or at most 99 (e.g., at most 95, at most 90, at most 85, at most 80, at most 75, at most 70, at most 65, at most 60, at most 55, at most 50, at most 45, at most 40, at most 35, at most 30, at most 25, at most 20, at most 15, at most 10, at most 9, at most 8, at most 7, at most 6, at most 5 at most 4, at most 3, at most 2, at most 1, at most 0.9, at most 0.8, at most 0.7, at most 0.6, at most 0.5, at most 0.4, at most 0.3, at most 0.2, at most 0.1) wt. % of manganese oxide. In some embodiments, the MONs include at least 0 (e.g., at least 0.1, at least 0.2, at least 0.3, at least 0.4, at least 0.5, at least 0.6, at least 0.7, at least 0.8, at least 0.9, at least 1, at least 2, at least 3, at least 4, at least 5, at least 6, at least 7, at least 8, at least 9, at least 10, at least 15, at least 20, at least 25, at least 30, at least 35, at least 40, at least 45, at least 50, at least 55, at least 60, at least 65, at least 70, at least 75, at least 80, at least 85, at least 90, at least 95) wt. % and/or at most 99 (e.g., at most 95, at most 90, at most 85, at most 80, at most 75, at most 70, at most 65, at most 60, at most 55, at most 50, at most 45, at most 40, at most 35, at most 30, at most 25, at most 20, at most 15, at most 10, at most 9, at most 8, at most 7, at most 6, at most 5 at most 4, at most 3, at most 2, at most 1, at most 0.9, at most 0.8, at most 0.7, at most 0.6, at most 0.5, at most 0.4, at most 0.3, at most 0.2, at most 0.1) wt. % of aluminum oxide. In some embodiments, the MONs include at least 0 (e.g., at least 0.1, at least 0.2, at least 0.3, at least 0.4, at least 0.5, at least 0.6, at least 0.7, at least 0.8, at least 0.9) wt. % and/or at most 1 (e.g., at most 0.9, at most 0.8, at most 0.7, at most 0.6, at most 0.5, at most 0.4, at most 0.3, at most 0.2, at most 0.1) wt. % of lithium oxide. In some embodiments, the MONs include at least 0 wt. % and/or at most 0.001 wt. % of iron oxide. In some embodiments, the MONs include at least 0 wt. % and/or at most 0.001 wt. % of copper oxide.

In some embodiments, the MONs are magnetic. In some embodiments, the metal oxide nanoparticles are ferromagnetic. In some embodiments, the density of the MONs (e.g., as determined by gas pycnometry) is at least 2.5 (e.g., at least 3, at least 3.5, at least 4, at least 4.5, at least 5, at least 5.5, at least 6) g/cm³ and/or at most 6.5 (e.g., at most 6, at most 5.5, at most 5, at most 4.5, at most 4, at most 3.5, at most 3) g/cm³. In some embodiments, the surface area of the MONs (e.g., as determined by BET method with nitrogen adsorption) is at least 5 (e.g., at least 10, at least 15, at least 20, at least 25, at least 30, at least 35, at least 40, at least 45, at least 50, at least 55, at least 60, at least 65, at least 70, at least 75, at least 80, at least 85, at least 90, at least 95, at least 100, at least 150, at least 200, at least 250) m²/g and/or at most 300 (e.g., at most 250, at most 200, at most 150, at most 100, at most 95, at most 90, at most 85, at most 80, at most 75, at most 70, at most 65, at most 60, at most 55, at most 50, at most 45, at most 40, at most 35, at most 30, at most 25, at most 20, at most 15, at most 10) m²/g.

### Drilling Fluids

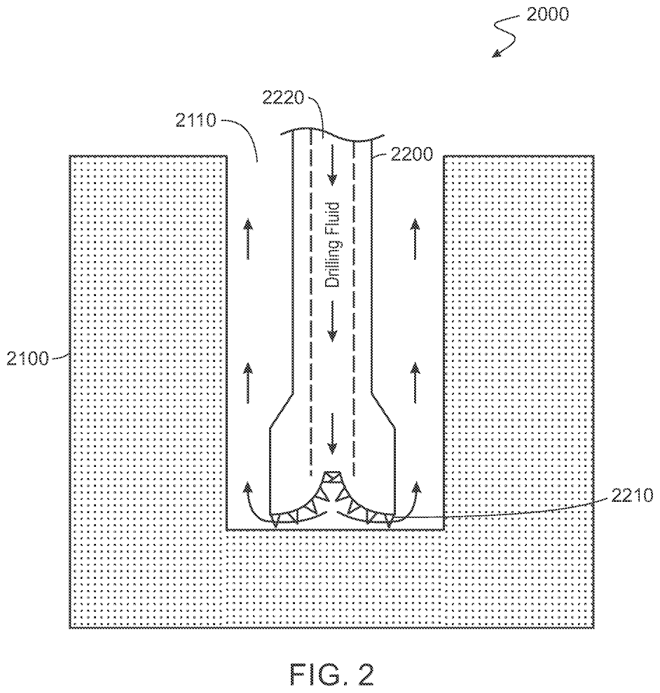

FIG. 2 depicts a schematic of a system 2000. The system includes an underground formation 2100 and a borehole 2110 extending into the underground formation 2100. A drill 2200 is used to drill the borehole 2110 into the underground formation 2100. The drill 2200 includes a drill bit 2210 to drill into the underground formation 2100 and a drill pipe 2220 through which a drilling fluid can be sent during use of the drill 2200. The drilling fluid is used to aid in the drilling of the borehole 2110. The MONs prepared using the method 1000 can be used in the drilling fluid. In some embodiments, the drilling fluid is a water-based drilling fluid.

To form the drilling fluid, the MONs using the method 1000 can be added to distilled water or brine to form a suspension. In certain embodiments, one or more biopolymers are added to the suspension. Alternatively, in some embodiments, the biopolymer(s) are added prior to the addition of the MONs or simultaneously with the MONs. Without wishing to be bound by theory, it is believed that the biopolymer(s) can function as gelling agents and fluid loss additives, increase the viscosity of the drilling fluids, and stabilize the MONs. The suspensions of the MONs are then sonicated (e.g., using an Ultrasonic disruptor). The suspensions are then added to drilling fluid and stirred to homogenize. In some embodiments, the sonication is performed for at least 10 (e.g., at least 20, at least 30, at least 40, at least 50) minutes and/or at most 60 (e.g., at most 50, at most 40, at most 30, at most 20) minutes.

In general, the suspension and the drilling fluid can include any desired or suitable amount of the MONs. Without wishing to be bound by theory, it is believed that increasing the concentration of the MONs can reduce filtering losses and/or increase viscosity. In general, intended characteristics of the drilling fluid are specified within a specific range and may be decided upon when creating a well drilling program. Thus, such constraints and economic considerations may also factor into the selection of the concentration of MONs in a given situation.

In some embodiments, the suspension includes at least 0.01 (e.g., at least 0.02, at least 0.03, at least 0.04, at least 0.05, at least 0.06, at least 0.07, at least 0.08, at least 0.09, at least 0.1, at least 0.2, at least 0.3, at least 0.4, at least 0.5, at least 0.6, at least 0.7, at least 0.8, at least 0.9, at least 1, at least 2, at least 3, at least 4) wt. % and/or at most 5 (e.g., at most 4, at most 3, at most 2, at most 1, at most 0.9, at most 0.8, at most 0.7, at most 0.6, at most 0.5, at most 0.4, at most 0.3, at most 0.2, at most 0.1, at most 0.09, at most 0.08, at most 0.07, at most 0.06, at most 0.05, at most 0.04, at most 0.03, at most 0.02) wt. % of the MONs. In some embodiments, the drilling fluid includes at least 0.005 (e.g., at least 0.01, at least 0.05, at least 0.1, at least 0.5, at least 1, at least 5) wt. % and/or at most 10 (e.g., at most 5, at most 1, at most 0.5, at most 0.1, at most 0.05, at most 0.01) wt. % of the MONs.

Examples of biopolymers include xanthan gum (XG), gum arabic (GA), cellulose, guar gum, and starch. In certain embodiments, the emulsion includes at least 0.01 (e.g., at least 0.02, at least 0.03, at least 0.04, at least 0.05, at least 0.06, at least 0.07, at least 0.08, at least 0.09, at least 0.1, at least 0.2, at least 0.3, at least 0.4, at least 0.5, at least 0.6, at least 0.7, at least 0.8, at least 0.9) wt. % and/or at most 1 (e.g., at most 0.9, at most 0.8, at most 0.7, at most 0.6, at most 0.5, at most 0.4, at most 0.3, at most 0.2, at most 0.1, at most 0.09, at most 0.08, at most 0.07, at most 0.06, at most 0.05, at most 0.04, at most 0.03, at most 0.02) wt. % of the biopolymer. In some embodiments, the drilling fluid includes at least 0.01 (e.g., at least 0.05, at least 0.1, at least 1) wt. % and/or at most 5 (e.g., at most 1, at most 0.5, at most 0.1, at most 0.05) wt. % of the biopolymer.

In some embodiments, the drilling fluid further includes of viscosifiers, dissolved salts, weighting agents, fluid loss control agents, deflocculating agents, lubricants, and/or inhibitors. In some embodiments, the drilling fluid includes 5-10 centipoise prehydrated bentonite slurry as a base and/or XG which acts as a viscosifier and provides good shear thinning and suspension characteristics to the drilling fluid. In some embodiments, 0.5-1 wt. % polyanionic cellulose (PAC-L) is added as a fluid loss control agent. In some embodiments, KCl is added to prepare an inhibitive mud (a mud that has the ability to prevent clay swelling) and obtain the desired density. In some embodiments, NaOH is used to provide a pH of 9 to 10 for the drilling fluid. In some embodiments, biocide is added to reduce (e.g., prevent) degradation of the biopolymers due to bacterial action.

The rheological and filtration properties of the drilling fluid can be tested using any appropriate method, such as before and after hot rolling under 100-150° C. for 8-16 hours. The hot rolling test can include mildly agitating the drilling fluid by rolling (or tumbling) for the duration of the test, usually performed at a selected temperature. Typically, the sample is sealed in a cell and placed in an oven that will roll (or tumble) the cell continually for a given period of time (often 16 hours or overnight). The cooled mud is tested for specific properties before and after agitation. Without wishing to be bound by theory, a rolled (or tumbled) mud sample simulates circulation in the hole by pumping. The temperature can be varied between room temperature (e.g., 20° C.) to 250° C. The pressure can be varied between atmospheric pressure and 500 psi.

Without wishing to be bound by theory, it is believed that the addition of MONs (e.g., 1 wt. %) results in increased plastic viscosity and yield point before and after heat exposure. Additionally, it is believed that filtration loss after hot rolling decreases drastically in comparison with drilling fluid without MONs, demonstrating the stability of drilling fluid with MONs under HTHP conditions.

Without wishing to be bound by theory, it is believed that due to the relatively high density of the MONs, they can be utilized as weighting materials in drilling fluids and drilling fluids that include the MONs can be used in areas with relatively high reservoir pressure. In some embodiments, the density of the drilling fluid with MONs is at least 1.05 (e.g., at least 1.1, at least 1.15, at least 1.2, at least 1.25, at least 1.3, at least 1.35, at least 1.4, at least 1.45, at least 1.5, at least 1.55, at least 1.6, at least 1.65, at least 1.7, at least 1.75, at least 1.8) g/cm³ and/or at most 1.85 (e.g., at most 1.8, at most 1.75, at most 1.7, at most 1.65, at most 1.6, at most 1.55, at most 1.5, at most 1.45, at most 1.4, at most 1.35, at most 1.3, at most 1.25, at most 1.2, at most 1.15, at most 1.1) g/cm³.

Without wishing to be bound by theory, it is believed that the MONs can enhance the rheological properties of drilling fluid due to the relatively high surface energies of the MONs and interactions with clay particles from the attachment of the MONs to edges of clay platelets and with positively charged ions present in the drilling fluid. However, an excessively high concentration of MONs may cause repulsion between the negatively charged MONs and other negatively charged additives in the drilling fluid, reducing (e.g., preventing) the aggregation of the clay particles and increasing the stability under high temperature and high pressure (HTHP) conditions. Without wishing to be bound by theory, it is believed that the use of the MONs in water-based drilling fluids can reduce filtration loss by to filling the micropores and nanopores in the filter cake.

Without wishing to be bound by theory, it is believed that electronic properties of certain MONs (e.g., cobalt oxide nanoparticles (Co₃O₄)) allows for the relatively fast and easy separation of the MONs from a fluid by the application of an external magnetic field. The MONs can be separated from a drilling fluid by magnetic separation and decantation and reused in subsequent preparations of drilling fluid.

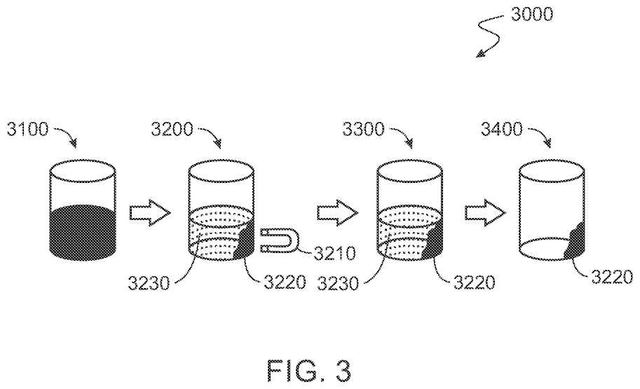

FIG. 3 depicts a schematic of a method 3000 of recovering MONs from a fluid (e.g., a drilling fluid). In step 3100, a solution including the MONs in a fluid is provided. In the 3200 a magnet 3210 is applied, causing the separation of the MONs 3220 from the fluid 3230.

In step 3300 the magnet 3210 is removed. Without wishing to be bound by theory, it is believed that aggregation of the MONs 3220 and their relatively high density prevent the MONs 3220 from remixing with the fluid 3230.

In step 3400, the fluid 3230 is removed and the MONs 3220 remain. The fluid 3230 can be removed using any appropriate methods, such as decanting. The method 3000 can also include centrifugation prior to the step 3400.

### Non-Limiting Examples

### Non-Limiting Example of Preparing Metal Oxide Nanoparticles

Cell discharging is performed by immersing a LIB cell or a cell bundle into 10 wt. % NH₄HCO₃ solution for 12 hours. After the discharging, cell's voltage is suppressed from an average of 4.0 V to 1.0 V allowing safe dismantling.

The cell is disassembled after removal from the alkali solution. After removing the stainless-steel battery case and unwinding, the cathode, anode, and separator are immersed into 2 M alkali solution to neutralize F-containing salts in the LIB's liquid electrolyte. The cathode tape is washed with ethanol or isopropanol, dried for 12 hours, and cut into 2×2 cm² pieces.

16 g of the cut cathode is placed into a glass conic flask, and 80 mL of DMF, DMSO, or NMP is added to remove the polymeric binder and detach the cathode active material from the Al substrate. After mild mixing for 6 hours at 80° C., the detached black mass is filtered, washed with ethanol or isopropanol, and dried at 70° C. and 100 mBar for 12 hours. From one LIB cell, it is possible to obtain up to 16 g of cathode material from a cylindric cell of a form factor of 18650 (18 mm diameter and 65 mm length).

The dissolution of the cathode material is performed by using a leaching mixture with an acidic agent and a reducing agent. The leaching solution can include 1.0 M H₂SO₄+5 vol. % H₂O₂ or 1.0 M.

The dissolution is carried out under intensive stirring at 80° C. for 6 hours. After the dissolution, the carbon residue (3 wt. %) is filtered out. The leaching efficiency is 95% depending on the element (Ni, Co, Mn), leaching solution composition, and leaching conditions.

Metal oxalate formation and precipitation is performed by a gentle dropping of a 1.0 M aqueous solution of oxalic acid into the portion of solution with the dissolved cathode's metals at pH of 2. The precipitated mixture of Ni, Mn, and Co oxalates is centrifuged, washed, and dried.

The metal oxalates are calcinated at 400° C. for 2 hours in air to produce metal oxide particles with the controllable average size ranging from 10 nm to 10 μm.

### Non-Limiting Example of Preparing Drilling Fluid

1 wt. % MONs (0.005 wt. % to 10 wt. % MONs can be used) are added to distilled water and stabilized by using 1 wt. % biopolymer. The biopolymer is xanthan gum (XG). Suspensions of MONs are sonicated for 30 minutes using an Ultrasonic disruptor. Then suspension is added to drilling mud, stirred, and homogenized in a Hamilton beach mixer.

Water-based drilling fluid with 5 centipoise PHBS (Prehydrated bentonite slurry) as a base is prepared with XG, which acts as a viscosifier and provides good shear thinning and suspension characteristics to the drilling fluid. Polyanionic cellulose (PAC-L) 0.5 wt. % is added as a fluid loss control agent. NaOH is used to establish a pH of 10 for the drilling fluid. Biocide (0.01 wt. %) is added to ensure that the biopolymers do not degrade due to bacterial action.

Finally, the rheological and filtration properties of drilling mud are tested before and after hot rolling under 100° C. for 16 hours. Experiments were conducted in accordance with ANSI/API RECOMMENDED PRACTICE 13B-1/ISO 10414-1:2008 (Identical) (Petroleum and natural gas industries—Field testing of drilling fluids—Part 1: Water-based fluids): Determination of viscosity and/or gel strength using a direct-indicating viscometer and High-temperature/high-pressure (HTHP) test.

Addition of 1% MONs to the water-based drilling fluid resulted in increased plastic viscosity (20%) and yield point (30%) before and after heat exposure. Moreover, filtration loss after hot rolling decreases drastically (55%) in comparison with the water-based drilling fluid without MONs, that demonstrates their stability under HTHP conditions. Percentages are changes in the properties of the drilling fluid with MONs relative to the drilling fluid without MONs.

### Embodiments

1. A method, including:
   dissolving a cathode material including a metal using a leaching solution including an acidic agent and a reducing agent to provide a first solution including ions of the metal;
   adding a second solution including a member selected from the group consisting of oxalic acid and an oxalate salt to the first solution to precipitate a metal oxalate; and
   calcining the metal oxalate to form metal oxide nanoparticles.
2. The method of embodiment 1, wherein the leaching solution includes from 0.5 M to 2 M of the acidic agent and from 2 vol. % to 10 vol. % of the reducing agent.
3. The method of embodiment 1 or 2, wherein:
   the acidic agent includes a member selected from the group consisting of sulfuric acid citric acid, tartaric acid, acetic acid, glycolic acid, maleic acid, succinic acid, acrylic acid, lactic acid, benzoic acid, and propionic acid; and
   the reducing agent includes a member selected from the group consisting of hydrogen peroxide, sodium bisulfite, ascorbic acid, and citric acid.
4. The method of any one of embodiments 1-3, wherein dissolving the cathode material is performed at a temperature of from 60° C. to 80° C.
5. The method of any one of embodiments 1-4, wherein the calcining is performed at a temperature of from 250° C. to 450° C.
6. The method of any one of embodiments 1-5, wherein the calcining is performed for from 1 hour to 4 hours.
7. The method of any one of embodiments 1-6, wherein the metal oxide nanoparticles include at least one member selected from the group consisting of nickel oxide, manganese oxide and cobalt oxide.
8. The method of embodiment 7, wherein the metal oxide nanoparticles include:
   from 0 to 99 wt. % nickel oxide;
   from 0 to 99 wt. % manganese oxide; and from 0 to 99 wt. % cobalt oxide.
9. The method of any one of embodiments 1-8, wherein the metal oxide nanoparticles have a size of from 10 nm to 10000 nm.
10. The method of any one of embodiments 1-9, further including, prior to adding the second solution, adjusting a pH of the first solution to from 2 to 7.
11. The method of any one of embodiments 1-10, further including, prior to dissolving the cathode material, isolating the cathode material from at least one other component of a lithium-ion battery, including contacting the cathode material with a solvent.
12. The method of embodiment 11, wherein contacting the cathode material with a solvent is performed at a temperature of from 65° C. to 90° C.
13. The method of embodiment 11 or 12, further including, prior to isolating the cathode material from at least one other component of a lithium-ion battery, dismantling a lithium-ion battery cell or bundle.
14. The method of embodiment 13, further including, prior to dismantling the lithium-ion battery cell or bundle, discharging the lithium-ion battery cell or bundle, including immersing the lithium-ion battery cell or bundle in an alkali solution.
15. The method of embodiment 14, wherein the alkali solution has a concentration of an alkali agent of from 5 wt. % to 15 wt. %.
16. The method of any one of embodiments 1-15, further including, forming a drilling fluid including the metal oxide nanoparticles.
17. The method of embodiment 16, wherein the drilling fluid is a water-based drilling fluid.
18. The method of embodiment 16 or 17, wherein the drilling fluid includes from 0.005 wt. % to 10 wt. % of the metal oxide nanoparticles.
19. The method of any one of embodiments 16-18, further including, using the drilling fluid in a drilling operation.
20. The method of embodiment 19, further including, recovering at least a portion of the drilling fluid after the drilling operation, and recovering at least a portion of the metal oxide nanoparticles from the recovered drilling fluid.

What is claimed:

1. A method, comprising:
dissolving a cathode material comprising a metal using a leaching solution comprising an acidic agent and a reducing agent to provide a first solution comprising ions of the metal;
adding a second solution comprising a member selected from the group consisting of oxalic acid and an oxalate salt to the first solution to precipitate a metal oxalate; and
calcining the metal oxalate to form metal oxide nanoparticles.

2. The method of claim 1, wherein the leaching solution comprises from 0.5 M to 2 M of the acidic agent and from 2 vol. % to 10 vol. % of the reducing agent.

3. The method of claim 1, wherein:
the acidic agent comprises a member selected from the group consisting of sulfuric acid citric acid, tartaric acid, acetic acid, glycolic acid, maleic acid, succinic acid, acrylic acid, lactic acid, benzoic acid, and propionic acid; and
the reducing agent comprises a member selected from the group consisting of hydrogen peroxide, sodium bisulfite, ascorbic acid, and citric acid.

4. The method of claim 1, wherein dissolving the cathode material is performed at a temperature of from 60° C. to 80° C.

5. The method of claim 1, wherein the calcining is performed at a temperature of from 250° C. to 450° C.

6. The method of claim 1, wherein the calcining is performed for from 1 hour to 4 hours.

7. The method of claim 1, wherein the metal oxide nanoparticles comprise at least one member selected from the group consisting of nickel oxide, manganese oxide and cobalt oxide.

8. The method of claim 7, wherein the metal oxide nanoparticles comprise:
from 0 to 99 wt. % nickel oxide;
from 0 to 99 wt. % manganese oxide; and
from 0 to 99 wt. % cobalt oxide.

9. The method of claim 1, wherein the metal oxide nanoparticles have a size of from 10 nm to 10000 nm.

10. The method of claim 1, further comprising, prior to adding the second solution, adjusting a pH of the first solution to from 2 to 7.

11. The method of claim 1, further comprising, prior to dissolving the cathode material, isolating the cathode material from at least one other component of a lithium-ion battery, comprising contacting the cathode material with a solvent.

12. The method of claim 11, wherein contacting the cathode material with a solvent is performed at a temperature of from 65° C. to 90° C.

13. The method of claim 11, further comprising, prior to isolating the cathode material from at least one other component of a lithium-ion battery, dismantling a lithium-ion battery cell or bundle.

14. The method of claim 13, further comprising, prior to dismantling the lithium-ion battery cell or bundle, discharging the lithium-ion battery cell or bundle, comprising immersing the lithium-ion battery cell or bundle in an alkali solution.

15. The method of claim 14, wherein the alkali solution has a concentration of an alkali agent of from 5 wt. % to 15 wt. %.

16. The method of claim 1, further comprising, forming a drilling fluid comprising the metal oxide nanoparticles.

17. The method of claim 16, wherein the drilling fluid is a water-based drilling fluid.

18. The method of claim 16, wherein the drilling fluid comprises from 0.005 wt. % to 10 wt. % of the metal oxide nanoparticles.

19. The method of claim 16, further comprising, using the drilling fluid in a drilling operation.

20. The method of claim 19, further comprising, recovering at least a portion of the drilling fluid after the drilling operation, and recovering at least a portion of the metal oxide nanoparticles from the recovered drilling fluid.
